(19) United States
(12) Patent Application Publication
(10) Pub. No.: US 2017/0303155 A1
(43) Pub. Date: Oct. 19, 2017

(54) METHOD AND APPARATUS FOR PROVIDING MEASUREMENT RESULTS IN A WIRELESS COMMUNICATION SYSTEM

(71) Applicant: LG ELECTRONICS INC., Seoul (KR)

(72) Inventors: Sangwon KIM, Seoul (KR); Jaewook LEE, Seoul (KR)

(73) Assignee: LG ELECTRONICS INC., Seoul (KR)

(21) Appl. No.: 15/489,408

(22) Filed: Apr. 17, 2017

Related U.S. Application Data
(60) Provisional application No. 62/324,305, filed on Apr. 18, 2016.

(51) Int. Cl. H04W 24/10; H04W 36/22

(52) U.S. Cl. CPC H04W 24/10; H04W 36/22

(57) ABSTRACT

Measurement results may be provided by a user equipment (UE) in a wireless communication system. The UE may receive a configuration for WLAN offloading; and if the configuration for WLAN offloading includes an RAN-assisted WLAN interworking configuration, and does not include an LTE-WLAN Aggregation (LWA) configuration and an LTE/WLAN Radio Level Integration with IPsec Tunnel (LWIP) configuration, the UE may provide the measurement results required for evaluation of a network selection and traffic steering rules to upper layers.

### CROSS-REFERENCE TO RELATED APPLICATIONS

Pursuant to 35 U.S.C. §119 (e), this application claims the benefit of U.S. Provisional Application No. 62/324,305, filed on Apr. 18, 2016, the contents of which are hereby incorporated by reference herein in its entirety.

### BACKGROUND OF THE INVENTION

### Field of the Invention

The present invention relates to wireless communications, and more particularly, to a method and an apparatus for providing measurement results in a wireless communication system.

### Related Art

3GPP (3rd Generation Partnership Project) LTE (long term evolution) which is improvement of UMTS (Universal Mobile Telecommunications System) has been introduced as 3GPP release 8. The 3GPP LTE uses OFDMA (orthogonal frequency division multiple access) in a downlink, and uses SC-FDMA (Single Carrier-frequency division multiple access) in an uplink. The 3GPP LTE adopts MIMO (multiple input multiple output) having maximum four antennas. Recently, a discussion of 3GPP LTE-A (LTE-Advanced) which is the evolution of the 3GPP LTE is in progress.

The wireless communication system can support providing a service through a plurality of access networks to the terminal. The terminal can receive the service from a 3GPP based access network such as a mobile wireless communication system and further, receive a service from non-3GPP based access networks such as Worldwide Interoperability for Microwave Access (WiMAX), Wireless Local Area Network (WLAN), and the like.

### SUMMARY OF THE INVENTION

Rel-12 WLAN AP and Rel-13 WLAN AP can be deployed together around a UE. However, the UE may not perform simultaneously Rel-13 WLAN interworking and Rel-12 WLAN interworking. This is because the UE can connect to only one WLAN AP at one time, but an AP which supports Rel-13 WLAN interworking does not support Rel-12 WLAN interworking. According to the prior art, if the UE support both Rel-12 WLAN interworking and Rel-13 WLAN interworking, the UE may try to steer traffic to WLAN using Rel-12 WLAN interworking rules even though the UE already performs LWA operation using Rel-13 WLAN interworking. Therefore, enhanced WLAN offload RAN evaluation for RAN-assisted WLAN interworking will be needed according to an embodiment of the present invention.

In an aspect, a method for providing, by a user equipment (UE), measurement results in a wireless communication system is provided. The method may include receiving a configuration for WLAN offloading; and if the configuration for WLAN offloading includes an RAN-assisted WLAN interworking configuration, and does not include an LTE-WLAN Aggregation (LWA) configuration and an LTE/WLAN Radio Level Integration with IPsec Tunnel (LWIP) configuration, providing the measurement results required for evaluation of a network selection and traffic steering rules to upper layers. The method may further include evaluating the network selection and the traffic steering rules.

The method may further include stopping providing the measurement results required for the evaluation of the network selection and the traffic steering rules to the upper layers if the configuration for WLAN offloading includes the RAN-assisted WLAN interworking configuration and at least one of the LWA configuration or the LWIP configuration.

The measurement results may be provided for the RAN-assisted WLAN interworking.

The RAN-assisted WLAN interworking configuration may be either wlan-OffloadConfigCommon or wlan-OffloadConfigDedicated.

The RAN-assisted WLAN interworking may be performed based on the access network selection and the traffic steering rules.

The RAN-assisted WLAN interworking may be performed based on ANDSF policies.

The LWA configuration may be used to setup, modify or release LTE-WLAN Aggregation.

The LWIP configuration may be used to add, modify or release DRBs that are using LWIP Tunnel.

The LWA configuration or the LWIP configuration may be received by including an RRC Connection Reconfiguration message from network.

The UE may be in an RRC_CONNECTED.

In another aspect, a method for providing, by a user equipment (UE), measurement results in a wireless communication system is provided. The method may include receiving a configuration for WLAN offloading; if the configuration for WLAN offloading includes an RAN-assisted WLAN interworking configuration and at least one of an LTE-WLAN Aggregation (LWA) configuration or an LTE/WLAN Radio Level Integration with IPsec Tunnel (LWIP) configuration, considering associated AP has highest priority; and providing the measurement results required for evaluation of a network selection and traffic steering rules to upper layers.

The measurement results may be provided for the RAN-assisted WLAN interworking.

The LWA configuration may be used to setup, modify or release LTE-WLAN Aggregation.

The LWIP configuration may be used to add, modify or release DRBs that are using LWIP Tunnel.

The UE does not try to steer traffic to WLAN using Rel-12 WLAN interworking rules when the UE already performs LWA operation using Rel-13 WLAN interworking.

### BRIEF DESCRIPTION OF THE DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows a structure of a wireless local area network (WLAN).

FIG. 5 shows an example of an environment where a 3GPP access network and a WLAN access network coexist.

FIG. 6 shows an overall architecture for the non-collocated LWA scenario.

FIG. 7 shows LWA radio protocol architecture.

FIG. 8 shows a network interfaces for LWA.

FIG. 9 shows a traffic steering operation in the RCLWI.

FIG. 10 shows an overall architecture for LWIP.

FIG. 11 shows a protocol architecture for LWIP.

FIG. 12 shows an end to end protocol stack for the bearer transported over the LWIP tunnel.

FIG. 13 is a block diagram illustrating a method for providing measurement results according to one embodiment of the present invention.

FIG. 14 is a block diagram illustrating a method for providing measurement results according to another embodiment of the present invention.

FIG. 15 is a block diagram illustrating a wireless communication system according to the embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

For clarity, the following description will focus on LTE-A. However, technical features of the present invention are not limited thereto.

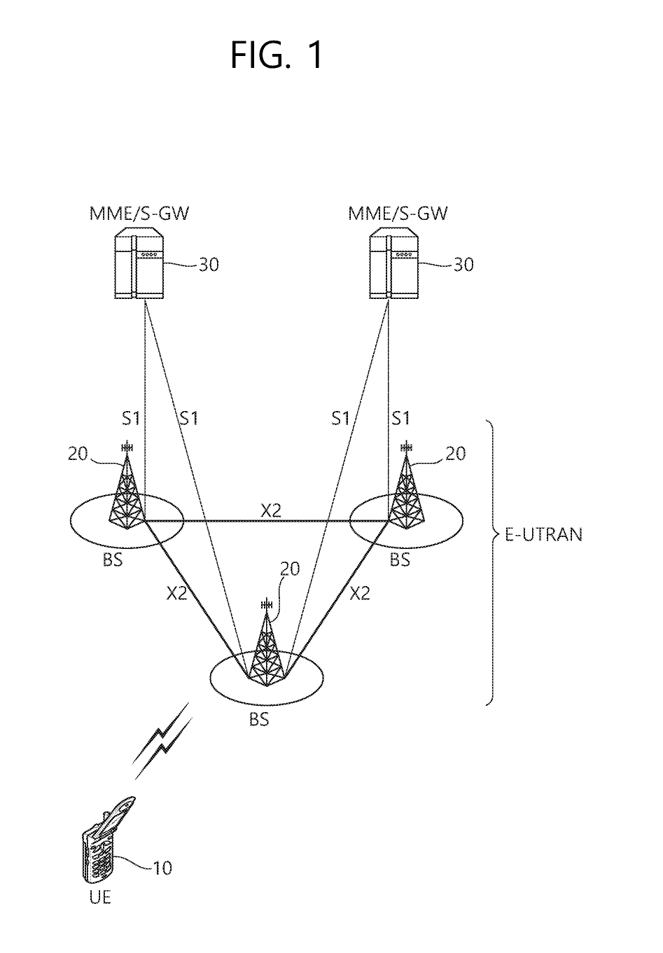

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE ACTIVE state. In the EPC, and as noted above, gateway 30 may perform functions of paging origination, LTE_IDLE state management, ciphering of the user plane, SAE bearer control, and ciphering and integrity protection of NAS signaling.

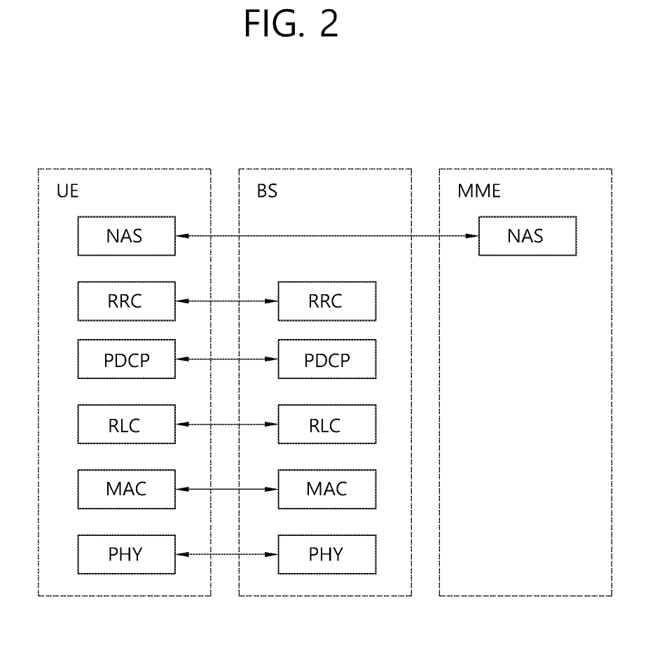

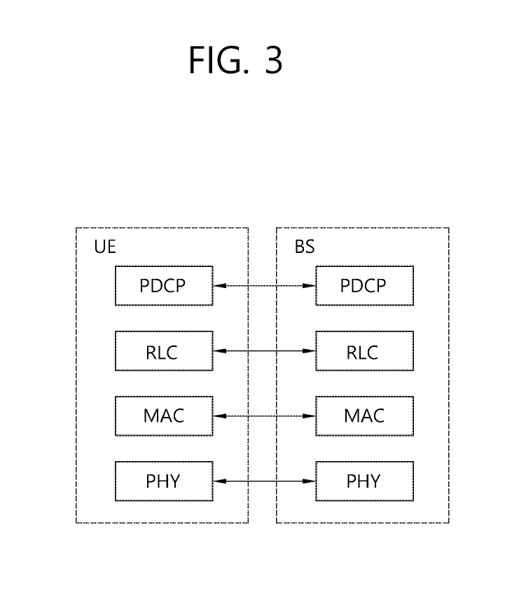

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from an upper layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

A Non-Access Stratum (NAS) layer placed over the RRC layer performs functions, such as session management and mobility management.

Referring to FIG. 2, the RLC and MAC layers (terminated in the eNB on the network side) may perform functions such as scheduling, automatic repeat request (ARQ), and hybrid automatic repeat request (HARQ). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

Hereinafter, an RRC State of a User Equipment (UE) and an RRC Connection Procedure are Described.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

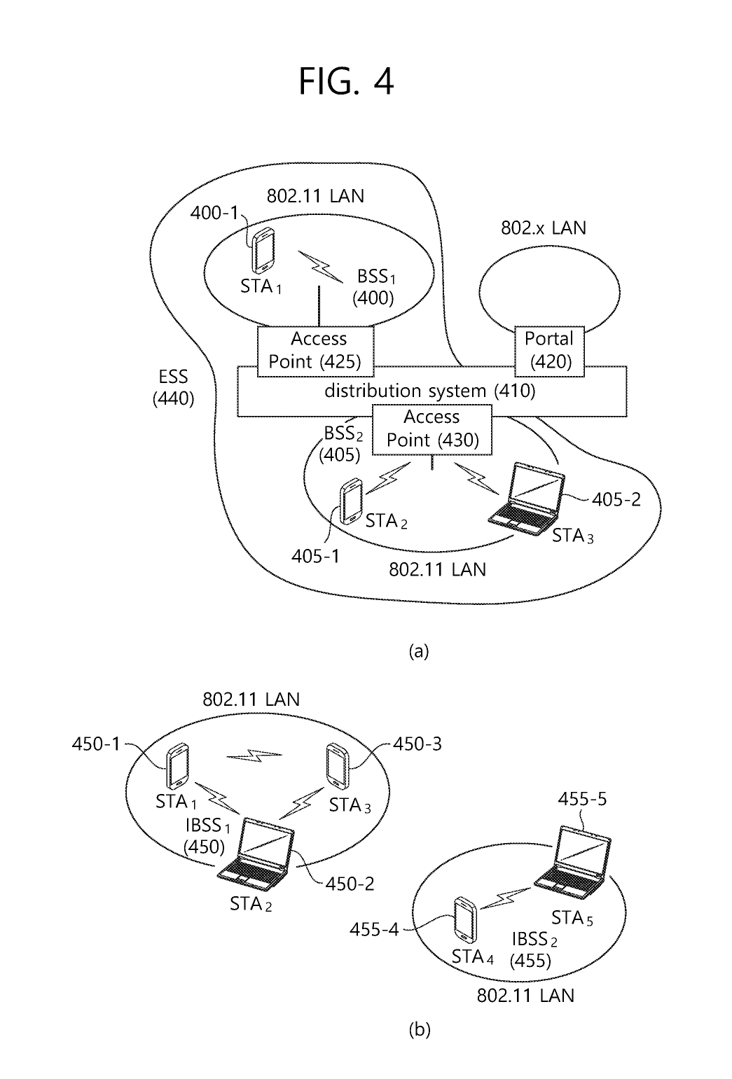

FIG. 4 shows a structure of a wireless local area network (WLAN). FIG. 4(a) shows a structure of the IEEE (institute of electrical and electronic engineers) 802.11 infrastructure network. FIG. 4(b) shows an independent basic service set (BSS).

Referring to FIG. 4(a), the WLAN system may include one or more basic service sets (BSSs, 400 and 405). The BSS 400 or 405 is a set of an AP such as AP (access point) 425 and an STA such as STA1 (station) 400-1 that may successfully sync with each other to communicate with each other and is not the concept to indicate a particular area. The BSS 405 may include one AP 430 and one or more STAs 405-1 and 405-2 connectable to the AP 430.

The infrastructure BSS may include at least one STA, APs 425 and 430 providing a distribution service, and a distribution system (DS) 410 connecting multiple APs.

The distribution system 410 may implement an extended service set (ESS) 440 by connecting a number of BSSs 400 and 405. The ESS 440 may be used as a term to denote one network configured of one or more APs 425 and 230 connected via the distribution system 410. The APs included in one ESS 440 may have the same SSID (service set identification).

The portal 420 may function as a bridge that performs connection of the WLAN network (IEEE 802.11) with other network (for example, 802.X).

In the infrastructure network as shown in FIG. 4(a), a network between the APs 425 and 430 and a network between the APs 425 and 430 and the STAs 400-1, 405-1, and 405-2 may be implemented. However, without the APs 425 and 430, a network may be established between the STAs to perform communication. The network that is established between the STAs without the APs 425 and 430 to perform communication is defined as an ad-hoc network or an independent BSS (basic service set).

Referring to FIG. 4(b), the independent BSS (IBSS) is a BSS operating in ad-hoc mode. The IBSS does not include an AP, so that it lacks a centralized management entity. In other words, in the IBSS, the STAs 450-1, 450-2, 450-3, 455-4, and 455-5 are managed in a distributed manner. In the IBSS, all of the STAs 450-1, 450-2, 450-3, 455-4, and 455-5 may be mobile STAs, and access to the distribution system is not allowed so that the IBSS forms a self-contained network.

The STA is some functional medium that includes a medium access control (MAC) following the IEEE (Institute of Electrical and Electronics Engineers) 802.11 standards and that includes a physical layer interface for radio media, and the term “STA” may, in its definition, include both an AP and a non-AP STA (station).

The STA may be referred to by various terms such as mobile terminal, wireless device, wireless transmit/receive unit (WTRU), user equipment (UE), mobile station (MS), mobile subscriber unit, or simply referred to as a user.

Hereinafter, RAN Assisted WLAN Interworking Between a 3GPP Access Network and Other Access Network is Described.

A 3GPP introduces interworking with a non-3GPP access network (e.g. WLAN) from Rel-8 to find accessible access network, and regulates ANDSF (Access Network Discovery and Selection Functions) for selection. An ANDSF transfers accessible access network finding information (e.g. WLAN, WiMAX location information and the like), Inter-System Mobility Policies (ISMP) capable of reflecting policies of a business, and an Inter-System Routing Policy (ISRP). The terminal may determine whether to transmit certain IP traffic through a certain access network. An ISMP may include a network selection rule with respect to selection of one active access network connection (e.g., WLAN or 3GPP) by the terminal. An ISRP may include a network selection rule with respect to selection of at least one potential active access network connection (e.g., both of WLAN and 3GPP) by the terminal. The ISRP includes Multiple Access PDN Connectivity (MAPCON), IP Flow Mobility (IFOM), and non-seamless WLAN offloading. For dynamic provision between the ANDSF and the terminal, Open Mobile Alliance Device Management (OMA DM) or the like are used.

The MAPCON simultaneously configures and maintains a plurality of packet data networks (multiple PDN connectivity) through a 3GPP access network and a non-3GPP access network and regulates a technology capable of performing seamless traffic offloading in the whole active PDN connection unit. To this end, an ANDSF server provides APN (Access Point Name) information to perform offloading, inter-access network priority (routing rule), Time of Day to which offloading method is applied, and access network (Validity Area) information to be offloaded.

The IFOM supports mobility and seamless offloading of an IP flow unit of flexible subdivided unit as compared with the MAPCON. A technical characteristic of the IFOM allows a terminal to access through different access network when the terminal is connected to a packet data network using an access point name (APN). Mobility and a unit of offloading may be moved in a specific service IP traffic flow unit which is not a packet data network (PDN), the technical characteristic of the IFOM has flexibility of providing a service. To this end, an ANDSF server provides IP flow information to perform offloading, priority (routing rule) between access networks, Time of Day to which an offloading method is applied, and Validity Area where offloading is performed.

The non-seamless WLAN offloading refers to a technology which changes a certain path of a specific IP traffic to a WLAN and completely offloads traffic without passing through an EPC. Since the non-seamless WLAN offloading is not anchored in P-GW for supporting mobility, offloaded IP traffic may not continuously moved to a 3GPP access network. To this end, the ANDSF server provides information similar to information to be provided for performing an IFOM.

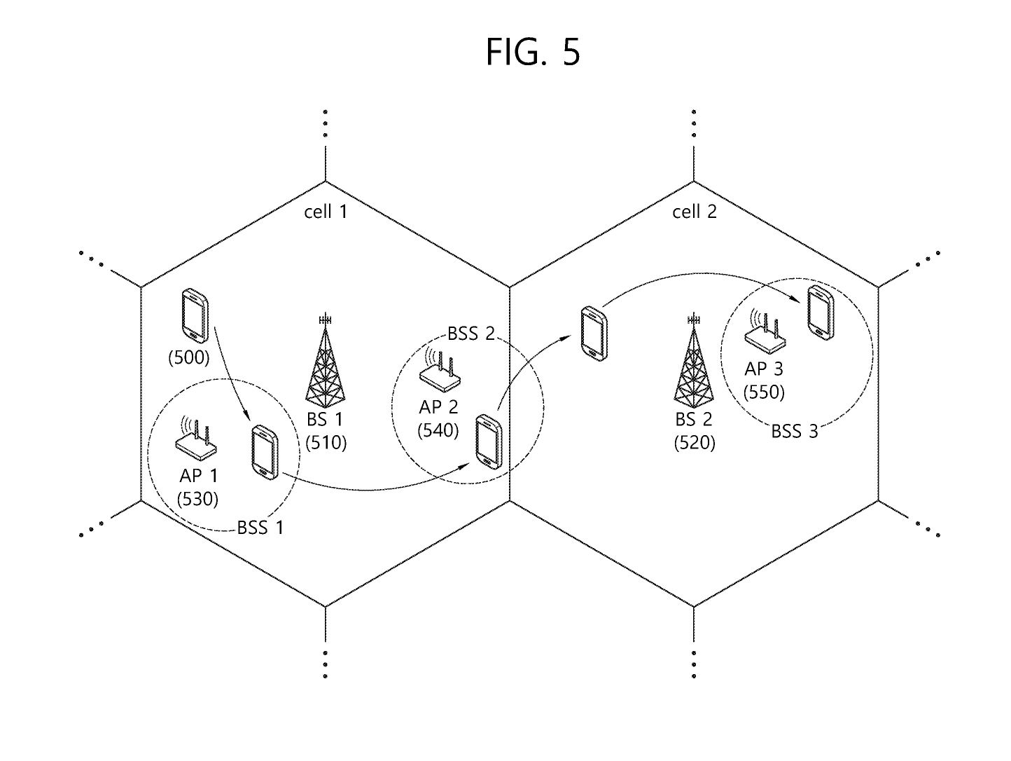

FIG. 5 shows an example of an environment where a 3GPP access network and a WLAN access network coexist.

Referring to FIG. 5, a cell 1 centering a base station 1 (510) and a cell 2 centering a base station 2 (520) are deployed as a 3GPP access network. Further, a Basic Service Set (BSS) 1 as the WLAN access network centering an Access Point (AP) 1 (530) located in a cell 1 and a BSS2 centering AP2 (540) and deployed. A BSS3 centering a AP3 (550) located in a cell 2 is deployed. Coverage of the cell is shown with a solid line, and coverage of BSS is shown with a dotted line.

It is assumed that the terminal 500 is configured to perform communication through a 3GPP access network and a WLAN access network. In this case, the terminal 500 may refer to a station.

First, the terminal 500 may establish connection with a BS1 (510) in a cell 1 to perform traffic through a 3GPP access network.

The terminal 500 may enters coverage of BSS1 while moving into coverage of cell 1. In this case, the terminal 500 may connect with a WLAN access network by performing association and authentication procedures with an AP1 (530) of BSS1. Accordingly, the terminal 500 may process traffic through a 3GPP access network and a WLAN access network. Meanwhile, the terminal 500 moves and is separated from the coverage BSS1, connection with a WLAN access network may be terminated.

The terminal 500 continuously move into the coverage of cell 1 and move around a boundary between cell 1 and cell 2, and enters coverage of BSS2 to find BSS2 through scanning. In this case, the terminal 500 may connect with the WLAN access network by performing association and authentication procedures of AP2 (540) of the BSS2. Meanwhile, since the terminal 500 in the coverage of the BSS2 is located at a boundary between the cell 1 and the cell 2, service quality through the 3GPP access network may not be excellent. In this case, the terminal 500 may operate to mainly process traffic through a WLAN access network.

When the terminal 500 moves and is separated from the coverage of the BSS2 and enters a center of the cell 2, the terminal 500 may terminate connection with the WLAN access network and may process traffic through a 3GPP access network based on the cell 2.

The terminal 500 may enter coverage of the BSS3 while moving into the coverage of cell 2 to find the BSS1 through scanning. In this case, the terminal 500 may connect with the WLAN access network by association and authentication procedures of an AP3 (550) of the BSS3. Accordingly, the terminal 500 may process the traffic through the 3GPP access network and the WLAN access network.

As illustrated in an example of FIG. 5, in a wireless communication environment where a 3GPP access network and a non-3GPP access network coexist, the terminal may adaptively process traffic through a 3GPP access network and/or a non-3GPP access network.

In a 3GPP Rel-13, LTE-WLAN Aggregation (LWA), RAN Controlled LTE-WLAN Interworking (RCLWI) and LTE/WLAN Radio Level Integration with IPsec Tunnel (LWIP) was newly introduced for a traffic steering between LTE and WLAN.

Hereinafter, LTE-WLAN Aggregation (LWA) is Described.

E-UTRAN supports LTE-WLAN aggregation (LWA) operation whereby a UE in RRC_CONNECTED is configured by the eNB to utilize radio resources of LTE and WLAN. Two scenarios are supported depending on the backhaul connection between LTE and WLAN:
non-collocated LWA scenario for a non-ideal backhaul;
collocated LWA scenario for an ideal/internal backhaul;

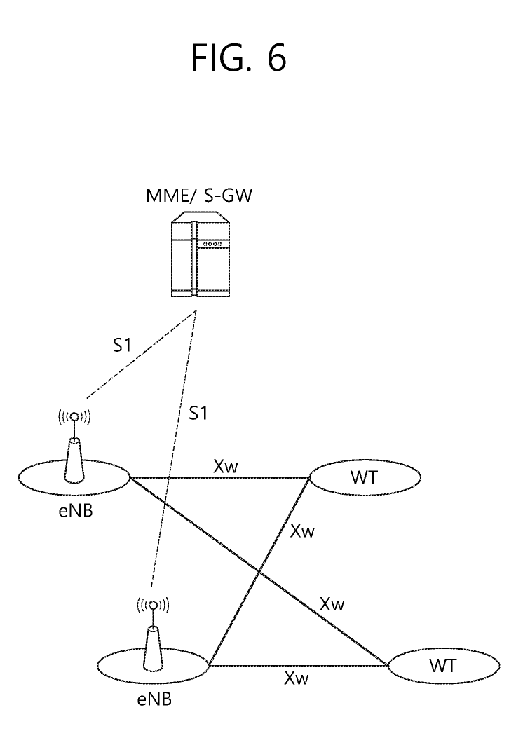

FIG. 6 shows an overall architecture for the non-collocated LWA scenario. Referring to FIG. 6, the WLAN Termination (WT) terminates the Xw interface for WLAN.

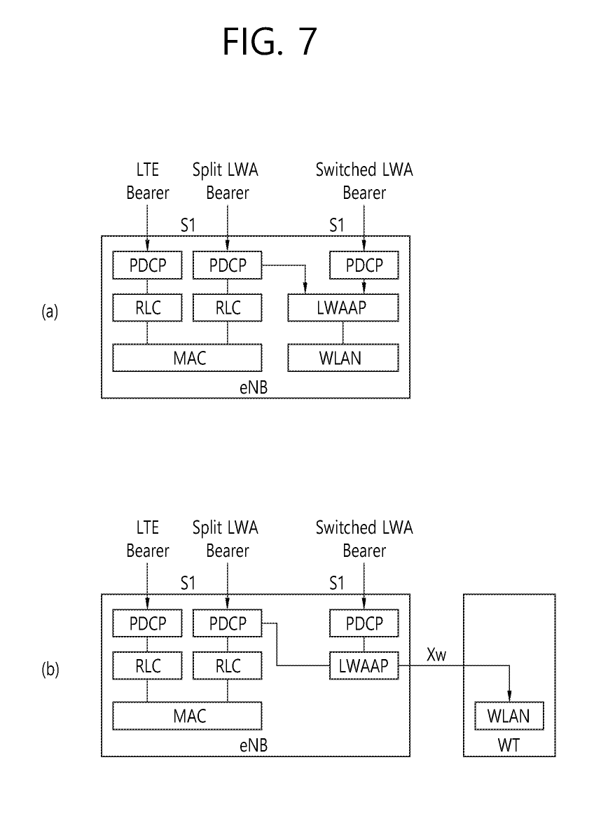

FIG. 7 shows LWA radio protocol architecture. Specifically, FIG. 7(a) shows LWA radio protocol architecture for the collocated scenario, and FIG. 7(b) shows LWA radio protocol architecture for the non-collocated scenario.

Referring to FIG. 7, in LWA, the radio protocol architecture that a particular bearer uses depends on the LWA backhaul scenario and how the bearer is set up. Two bearer types exist for LWA: split LWA bearer and switched LWA bearer.

For PDUs sent over WLAN in LWA operation, the LWAAP entity generates LWA PDU containing a DRB identity and the WT uses the LWA EtherType 0x9E65 for forwarding the data to the UE over WLAN. The UE uses the LWA EtherType to determine that the received PDU belongs to an LWA bearer and uses the DRB identity to determine to which LWA bearer the PDU belongs to. In the downlink, LWA supports split bearer operation where the PDCP sublayer of the UE supports in-sequence delivery of upper layer PDUs based on the reordering procedure introduced for DC. In the uplink, PDCP PDUs can only be sent via the LTE. The UE supporting LWA may be configured by the eNB to send PDCP status report or LWA PDCP status report, in cases where feedback from WT is not available. Only RLC AM can be configured for the LWA bearer.

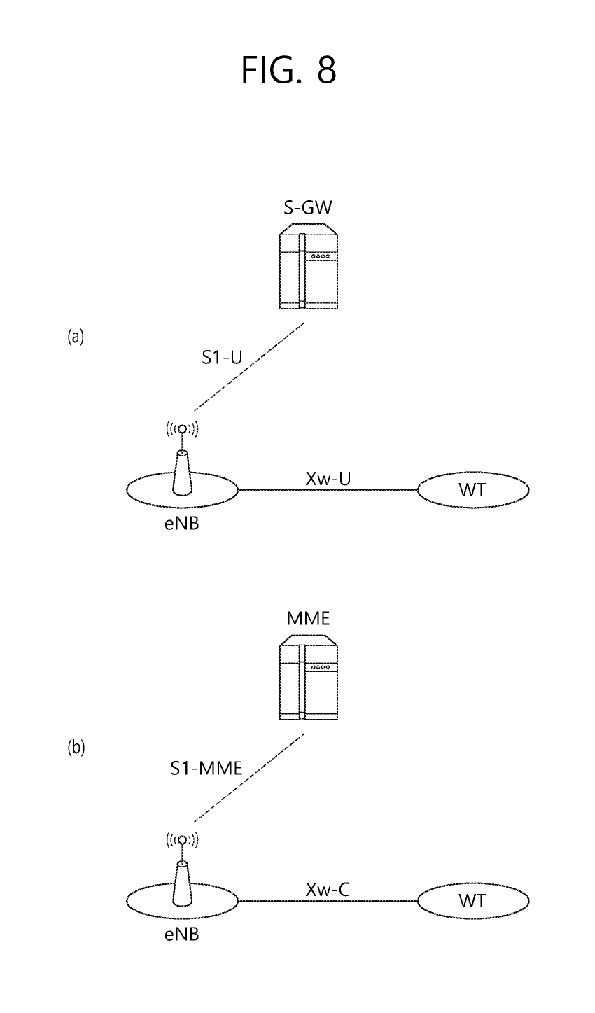

FIG. 8 shows a network interfaces for LWA. Specifically, FIG. 8(a) shows a U-Plane connectivity of eNB and WT for LWA, and FIG. 8(b) shows a C-Plane connectivity of eNB and WT for LWA.

In the non-collocated LWA scenario, the eNB is connected to one or more WTs via an Xw interface. In the collocated LWA scenario the interface between LTE and WLAN is up to implementation. For LWA, the only required interfaces to the Core Network are S1-U and S1-MME which are terminated at the eNB. No Core Network interface is required for the WLAN.

Referring to FIG. 8(a), in the non-collocated LWA scenario, the Xw user plane interface (Xw-U) is defined between eNB and WT. The Xw-U interface supports flow control based on feedback from WT. The Flow Control function is applied in the downlink when an E-RAB is mapped onto an LWA bearer, i.e. the flow control information is provided by the WT to the eNB for the eNB to control the downlink user data flow to the WT for the LWA bearer. The OAM configures the eNB with the information of whether the Xw DL delivery status provided from a connected WT concerns LWAAP PDUs successfully delivered to the UE or successfully transferred toward the UE. The Xw-U interface is used to deliver LWA PDUs between eNB and WT. For LWA, the S1-U terminates in the eNB and, if Xw-U user data bearers are associated with E-RABs for which the LWA bearer option is configured, the user plane data is transferred from eNB to WT using the Xw-U interface.

Referring to FIG. 8(b), in the non-collocated LWA scenario, the Xw control plane interface (Xw-C) is defined between eNB and WT. The application layer signalling protocol is referred to as Xw-AP (Xw Application Protocol).

The Xw-AP protocol supports the following functions:
Transfer of WLAN metrics (e.g. bss load) from WT to eNB;
Support of LWA for UE in ECM-CONNECTED: Establishment, Modification and Release of a UE context at the WT, or Control of user plane tunnels between eNB and WT for a specific UE for LWA bearers.
General Xw management and error handling functions: Error indication, Setting up the Xw, Resetting the Xw, or Updating the WT configuration data.

eNB-WT control plane signalling for LWA is performed by means of Xw-C interface signalling. There is only one S1-MME connection per LWA UE between the eNB and the MME. Respective coordination between eNB and WT is performed by means of Xw interface signalling.

Hereinafter, mobility and WLAN measurements in the LWA are described.

A WLAN mobility set is a set of one or more WLAN Access Points (APs) identified by one or more BSSID/HESSID/SSIDs, within which WLAN mobility mechanisms apply while the UE is configured with LWA bearer(s), i.e., the UE may perform mobility between WLAN APs belonging to the mobility set without informing the eNB. The eNB provides the UE with a WLAN mobility set. When the UE is configured with a WLAN mobility set, it will attempt to connect to a WLAN whose identifiers match the ones of the configured mobility set. UE mobility to WLAN APs not belonging to the UE mobility set is controlled by the eNB e.g. updating the WLAN mobility set based on measurement reports provided by the UE. A UE is connected to at most one mobility set at a time. All APs belonging to a mobility set share a common WT which terminates Xw-C and Xw-U. The termination endpoints for Xw-C and Xw-U may differ. The WLAN identifiers belonging to a mobility set may be a subset of all WLAN identifiers associated to the WT.

The UE supporting LWA may be configured by the E-UTRAN to perform WLAN measurements. WLAN measurement object can be configured using WLAN identifiers (BSSID, HESSID and SSID), WLAN channel number and WLAN band. WLAN measurement reporting is triggered using RSSI. WLAN measurement report may contain RSSI, channel utilization, station count, admission capacity, backhaul rate and WLAN identifier.

WLAN measurements may be configured to support the following:
LWA activation;
Inter WLAN mobility set mobility;
LWA deactivation.

UE is configured with measurements for WLAN using IEEE terminology (e.g. ‘Country’, ‘Operating Class’, and/or ‘Channel Number’).

Hereinafter, RAN Controlled LTE-WLAN Interworking (RCLWI) is Described.

Similarly as for LWA, in the non-collocated RCLWI scenario, the eNB is connected to one or more WT logical nodes via an Xw interface and in the collocated RCLWI scenario the interface between LTE and WLAN is up to implementation.

There is no user plane interface defined between the eNB and the WT in RCLWI.

In the non-collocated RCLWI scenario, the Xw control plane interface (Xw-C) is defined between the eNB and the WT and is similar to what is defined for LWA in FIG. 8(b). LWA specific functions are not part of RCLWI.

A WLAN mobility set is a set of one or more BSSID/HESSID/SSIDs, within which WLAN mobility mechanisms apply while the UE has moved offloadable PDN connections to WLAN according to a steering command, i.e. the UE may perform mobility between WLAN APs belonging to the mobility set without informing the eNB.

The UE supporting RCLWI may be configured by the E-UTRAN to perform WLAN measurements. WLAN measurement object can be configured using WLAN identifiers (BSSID, HESSID and SSID), WLAN channel number and WLAN band. WLAN measurement reporting is triggered using RSSI. WLAN measurement report may contain RSSI, channel utilization, station count, admission capacity, backhaul rate and WLAN identifier.

Hereinafter, procedure for WLAN Connection Status Reporting in the RCLWI is described.

The purpose of the WLAN Connection Status Reporting procedure is to provide feedback to the eNB related to the WLAN status and operation. The WLAN Connection Status Reporting procedure supports the following indications:
Failure of establishing/maintaining a WLAN connection.
Successful establishment of a WLAN connection.

When a UE configured to offload to WLAN becomes unable to establish or continue WLAN offloading, the UE sends the WLANConnectionStatusReport message to indicate to the eNB that the WLAN connection failed and the UE moves all the offloaded PDN connections to E-UTRAN. If configured, the UE sends the WLANConnectionStatusReport message upon successful establishment of a WLAN connection to indicate to E-UTRAN that a WLAN connection has successfully been established.

The UE is not required to send the WLANConnectionStatusReport message if it successfully re-associates to another AP within the WLAN mobility set.

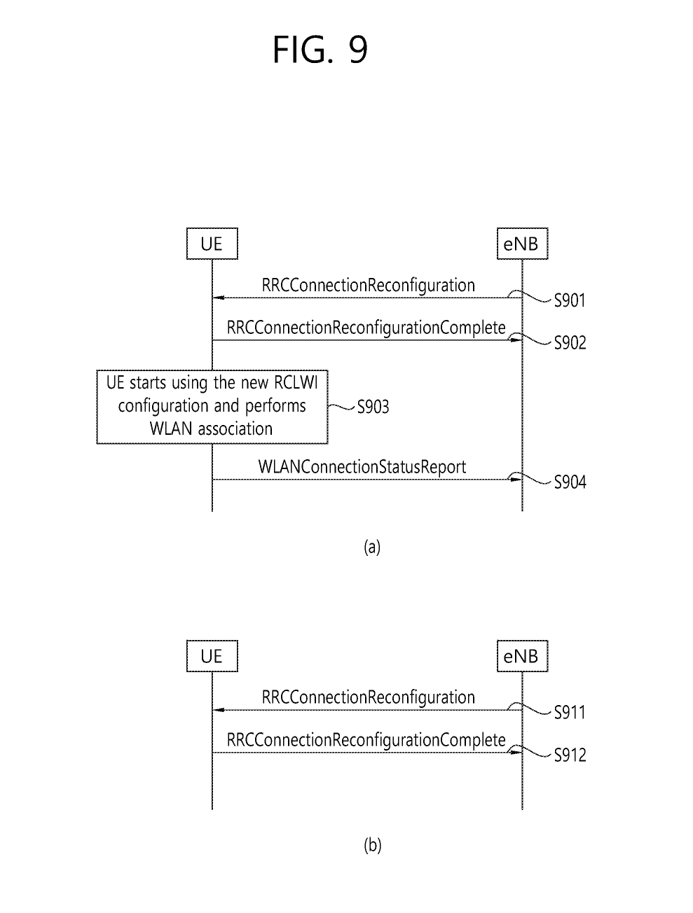

FIG. 9 shows a traffic steering operation in the RCLWI. Specifically, FIG. 9(a) shows the traffic steering from E-UTRAN to WLAN, and FIG. 9(b) shows the traffic steering from WLAN to E-UTRAN.

Referring to FIG. 9(a), the traffic steering from E-UTRAN to WLAN procedure is initiated by the eNB. In S901 step, the eNB sends the RRCConnectionReconfiguration message to the UE indicating the UE to steer traffic from E-UTRAN to WLAN. In S902 step, the UE forward the indication to upper layers and replies with RRCConnectionReconfigurationComplete message. In S903 step, the UE performs WLAN Association and steers traffic from E-UTRAN to WLAN (subject to upper layer). In S904 step, if configured by the eNB, the UE sends WLANConnectionStatusReport message.

Referring to FIG. 9(b), the traffic steering from WLAN to E-UTRAN procedure is initiated by the eNB. In S911 step, the eNB sends the RRCConnectionReconfiguration message to the UE indicating the UE to steer traffic from WLAN to E-UTRAN. In S912 step, the UE forward the indication to upper layers and replies with RRCConnectionReconfigurationComplete message. And then, the UE steers traffic from WLAN to E-UTRAN.

Hereinafter, LTE/WLAN Radio Level Integration with IPsec Tunnel (LWIP) is Described.

LTE/WLAN Radio Level Integration with IPsec Tunnel (LWIP) feature allows a UE in RRC_CONNECTED to be configured by the eNB to utilize WLAN radio resources via IPsec tunneling.

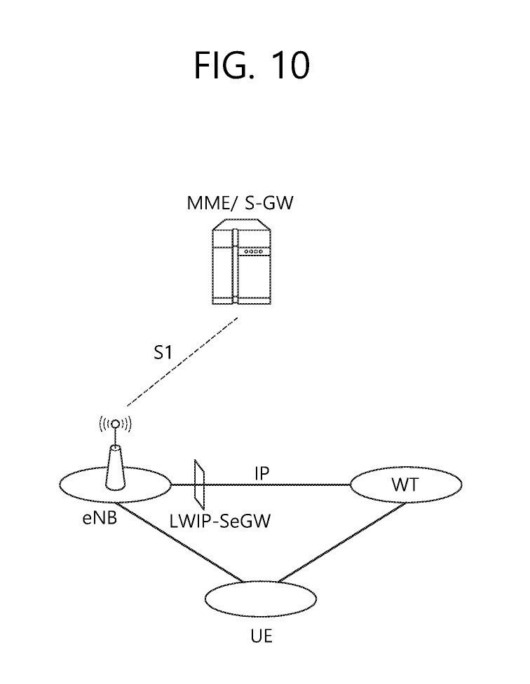

FIG. 10 shows an overall architecture for LWIP.

Referring to FIG. 10, connectivity between eNB and WLAN is over IP.

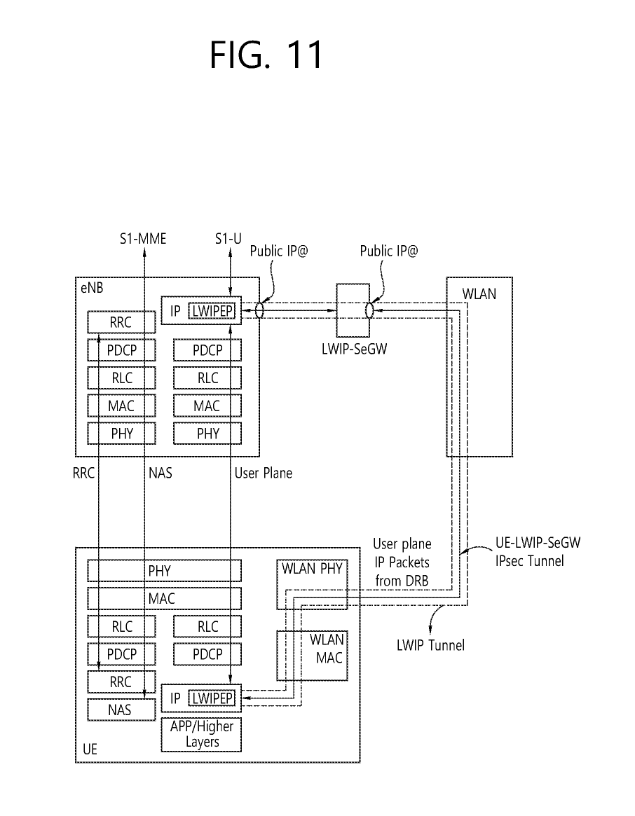

FIG. 11 shows a protocol architecture for LWIP.

Referring to FIG. 11, the IP Packets transferred between the UE and LWIP-SeGW are encapsulated using IPsec in order to provide security to the packets that traverse WLAN. The IP packets are then transported between the LWIP-SeGW and eNB. The end to end path between the UE and eNB via the WLAN network is referred to as the LWIP tunnel.

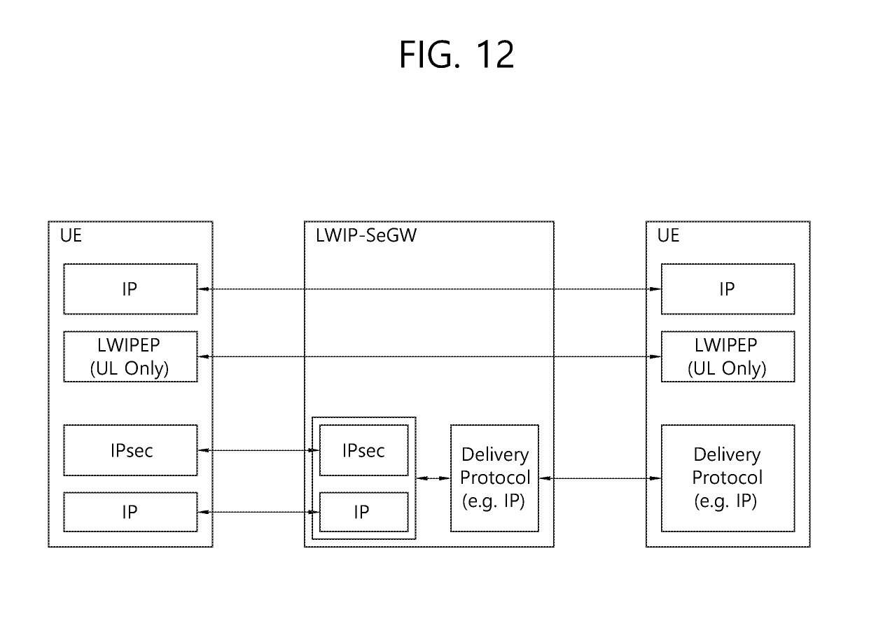

FIG. 12 shows an end to end protocol stack for the bearer transported over the LWIP tunnel.

The RRCConnectionReconfiguration message provides the necessary parameters for the UE to initiate the establishment of the IPSec tunnel for the DRB. When the IPsec tunnel is established a data bearer can be configured to use LWIP resources. The DRB configuration on the LTE access corresponding to the data bearer using IPsec resources shall not be released. The data bearer refers to the EPS bearer mapped to the data radio bearer (DRB) which is maintained on the LTE side.

A single IPSec tunnel is used per UE for all the data bearers that are configured to send and/or receive data over WLAN. Each data bearer may be configured so that traffic for that bearer can be routed over the IPsec tunnel in either only downlink or both uplink and downlink over WLAN. SRBs are carried over LTE only. eNB configures specific bearer(s) to use the IPsec tunnel.

If the IPsec tunnel is established then it is expected that eNB routes packets belonging to the data bearer via the LTE access or via the IPSec tunnel. If eNB implementation routes packets to both LTE Access and the IPSec tunnel simultaneously, then delivery of packets to upper layers at the UE may occur out of order.

For the DL of a data bearer, the packets received from the IPsec tunnel are forwarded directly to upper layers. For the UL, the eNB configures the UE to route the uplink data either via LTE or via WLAN using RRC signaling. If routed via WLAN then all UL traffic of the data bearer is offloaded to the WLAN. The release of the IPsec tunnel is initiated by the eNB. Upon receiving the Handover Command or on transition to RRC_IDLE state, the UE shall autonomously release IPsec tunnel configuration and the use of it by the data bearers. A UE supporting LWIP may be configured for WLAN measurements for LWA. The same mobility concept for LWA is also used for LWIP. Since, WT node does not exist in LWIP operation, WT related description and procedures does not apply to LWIP. Mobility Set should be considered as the set of WLAN APs across which UE can perform mobility without informing the eNB, when applying the concept for LWIP operation. The same UE cannot be simultaneously configured with LWA and LWIP.

Rel-12 WLAN AP and Rel-13 WLAN AP can be deployed together around a UE. However, the UE may not perform simultaneously Rel-13 WLAN interworking and Rel-12 WLAN interworking. This is because the UE can connect to only one WLAN AP at one time, but an AP which supports Rel-13 WLAN interworking does not support Rel-12 WLAN interworking. According to the prior art, if the UE support both Rel-12 WLAN interworking and Rel-13 WLAN interworking, the UE may try to steer traffic to WLAN using Rel-12 WLAN interworking rules even though the UE already performs LWA operation using Rel-13 WLAN interworking. In the present specification, the Rel-12 WLAN interworking may be RAN-assisted WLAN interworking, and the Rel-13 WLAN interworking may be at least one of LWA or LWIP. Therefore, enhanced WLAN offload RAN evaluation for RAN-assisted WLAN interworking will be needed according to an embodiment of the present invention.

Hereinafter, enhanced WLAN offload RAN evaluation for RAN-assisted WLAN interworking according to an embodiment of the present invention is described.

A user equipment (UE) provides measurement results required for the evaluation of the network selection and traffic steering rules to upper layers, only when following conditions are met:
if the UE is configured with an RAN-assisted WLAN interworking configuration, and
if the UE is not configured with an LTE-WLAN Aggregation (LWA) configuration, and
if the UE is not configured with an LTE/WLAN Radio Level Integration with IPsec Tunnel (LWIP) configuration.

The UE may be in RRC_CONNECTED mode. The evaluation of the network selection and traffic steering rules are defined in 3GPP TS 24.312 V13.2.0 (2016-03).

The RAN-assisted WLAN interworking configuration may be either wlan-OffloadConfigCommon or wlan-OffloadConfigDedicated. The LWA configuration may be lwa-Configuration, and the LWIP configuration may be lwip-Configuration.

The wlan-OffloadConfigCommon and wlan-OffloadConfigDedicated are information relevant for traffic steering between E-UTRAN and WLAN.

The wlan-OffloadConfigCommon may be contained in SystemInformationBlockType17 as shown in Table 1.

TABLE 1

| | |
|---|---|
| WLAN-OffloadInfoPerPLMN-r12 ::= | SEQUENCE { |

| | |
|---|---|
| wlan-OffloadConfigCommon-r12 | WLAN-OffloadConfig-r12 |

| | |
|---|---|
| OPTIONAL, | -- Need OR |

| | |
|---|---|
| wlan-Id-List-r12 | WLAN-Id-List-r12 |

| | |
|---|---|
| OPTIONAL, | -- Need OR |

...

}

The wlan-OffloadConfigDedicated may be contained in RRC Connection Reconfiguration message as shown in Table 2.

TABLE 2
RRCConnectionReconfiguration-v1250-IEs ::= SEQUENCE {

| | |
|---|---|
| wlan-OffloadInfo-r12 | CHOICE { |

| | |
|---|---|
| release | NULL, |
| setup | |

SEQUENCE {

| | |
|---|---|
| wlan-OffloadConfigDedicated-r12 | WLAN-OffloadConfig-r12, |

t350-r12

| ENUMERATED {min5, min10, min20, min30, min60, | |
|---|---|
| min120, min180, spare1} OPTIONAL | -- Need OR |

}

}

| | |
|---|---|
| OPTIONAL, | -- Need |

ON

| | |
|---|---|
| scg-Configuration-r12 | SCG-Configuration-r12 |

| | |
|---|---|
| OPTIONAL, | -- Cond nonFullConfig |

| | |
|---|---|
| sl-SyncTxControl-r12 | SL-SyncTxControl-r12 |

| | |
|---|---|
| OPTIONAL, | -- Need ON |

| | |
|---|---|
| sl-DiscConfig-r12 | SL-DiscConfig-r12 |

| | |
|---|---|
| OPTIONAL, | -- Need ON |

| | |
|---|---|
| sl-CommConfig-r12 | SL-CommConfig-r12 |

| | |
|---|---|
| OPTIONAL, | -- Need ON |

| | |
|---|---|
| nonCriticalExtension | RRCConnectionReconfiguration- |

| | |
|---|---|
| v1310-IEs | OPTIONAL |

}

The lwa-Configuration may be used to setup, modify or release LTE-WLAN Aggregation. The lwa-Configuration may be defined as shown in Table 3.

TABLE 3

| | |
|---|---|
| LWA-Configuration-r13 ::= | CHOICE { |

| | |
|---|---|
| release | NULL, |
| setup | SEQUENCE { |

| | |
|---|---|
| lwa-Config-r13 | LWA-Config-r13 |

}

}

| | |
|---|---|
| LWA-Config-r13 ::= | SEQUENCE { |

| | |
|---|---|
| lwa-Mobility Config-r13 | WLAN-MobilityConfig-r13 |

| | |
|---|---|
| OPTIONAL, | -- Need ON |

| | |
|---|---|
| lwa-WT-Counter-r13 | INTEGER (0..65535) |

| | |
|---|---|
| OPTIONAL, | -- Need ON |

...

}

The lwa-Configuration may be contained in RRC Connection Reconfiguration message as shown in Table 4.

TABLE 4
RRCConnectionReconfiguration-v1310-IEs ::= SEQUENCE {

| sCellToReleaseListExt-r13 | | SCellToReleaseListExt-r13 |
|---|---|---|
| OPTIONAL, | -- Need ON | |
| sCellToAddModListExt-r13 | | SCellToAddModListExt-r13 |
| OPTIONAL, | -- Need ON | |

| | |
|---|---|
| lwa-Configuration-r13 | LWA-Configuration-r13 |

| | |
|---|---|
| OPTIONAL, | -- Need ON |

| | |
|---|---|
| lwip-Configuration-r13 | LWIP-Configuration-r13 |

| | |
|---|---|
| OPTIONAL, | -- Need ON |

| | |
|---|---|
| nonCriticalExtension | RRCConnectionReconfiguration- |

| | |
|---|---|
| v14x0-IEs | OPTIONAL |

}

The lwip-Configuration may be used to add, modify or release DRBs that are using LWIP Tunnel. The lwip-Configuration may be defined as shown in Table 5. The lwip-Configuration may be contained in RRC Connection Reconfiguration message as shown in Table 4.

TABLE 5

| | |
|---|---|
| LWIP-Configuration-r13 ::= | CHOICE { |

| | |
|---|---|
| release | NULL, |
| setup | SEQUENCE { |

| | |
|---|---|
| lwip-Config-r13 | LWIP-Config-r13 |

}

}

| | |
|---|---|
| LWIP-Config-r13 ::= | SEQUENCE { |

| | |
|---|---|
| lwip-MobilityConfig-r13 | WLAN-MobilityConfig-r13 |

| | |
|---|---|
| OPTIONAL, | -- Need ON |

| | |
|---|---|
| tunnelConfigLWIP-r13 | TunnelConfigLWIP-r13 |

| | |
|---|---|
| OPTIONAL, | -- Need ON |
| ... | |

}

For example, according to one embodiment of the present invention, the UE provides measurement results required for the evaluation of the network selection and traffic steering rules, when following conditions are met:
if the UE is configured with either wlan-OffloadConfigCommon or wlan-OffloadConfigDedicated; and
if none of lwa-Configuration and lwip-Configuration is configured:

After providing measurement results, the UE evaluates the network selection and traffic steering rules using WLAN identifiers as indicated in other subclauses (either provided in wlan-Id-List included in SystemInformationBlockType17). The network selection and traffic steering rules are defined in 3GPP TS 36.304 V13.1.0 (2016-03).

For example, according to another embodiment of the present invention, the UE does not provide measurement results required for the evaluation of the network selection and traffic steering rules to upper layers, when following conditions are met:
if the UE is configured with either the wlan-OffloadConfigCommon or the wlan-OffloadConfigDedicated, and
if the UE is configured with at least one of the lwa-Configuration or the lwip-Configuration.

Thus, the RAN-assisted WLAN interworking is not performed even if the the UE is configured with wlan-OffloadConfigCommon or the wlan-OffloadConfigDedicated.

Alternatively, if a UE is configured with the LWA configuration or LWIP configuration, the UE considers the associated AP has higher priority or the highest priority. In this case, even though UE provides measurement results required for the evaluation of the network selection and traffic steering rules to upper layers, the upper layer doesn't perform access network selection and traffic steering.

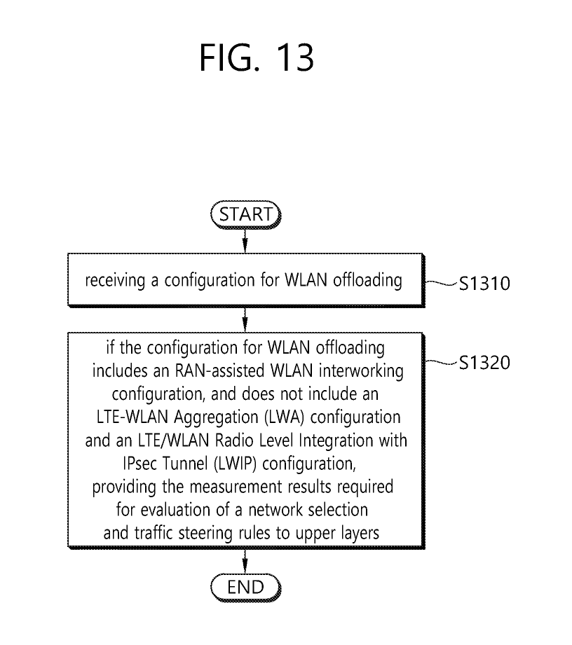

FIG. 13 is a block diagram illustrating a method for providing measurement results according to one embodiment of the present invention.

Referring to FIG. 13, in step S1310, the UE may receive a configuration for WLAN offloading.

In step S1320, if the configuration for WLAN offloading includes an RAN-assisted WLAN interworking configuration, and does not include an LTE-WLAN Aggregation (LWA) configuration and an LTE/WLAN Radio Level Integration with IPsec Tunnel (LWIP) configuration, the UE may provide the measurement results required for evaluation of a network selection and traffic steering rules to upper layers. The UE may evaluate the network selection and the traffic steering rules.

Additionally, if the configuration for WLAN offloading includes the RAN-assisted WLAN interworking configuration and at least one of the LWA configuration or the LWIP configuration, the UE may stop providing the measurement results required for the evaluation of the network selection and the traffic steering rules to the upper layers.

The measurement results may be provided for the RAN-assisted WLAN interworking.

The RAN-assisted WLAN interworking configuration may be either wlan-OffloadConfigCommon or wlan-OffloadConfigDedicated.

The RAN-assisted WLAN interworking may be performed based on the access network selection and the traffic steering rules.

The RAN-assisted WLAN interworking may be performed based on ANDSF policies.

The LWA configuration may be used to setup, modify or release LTE-WLAN Aggregation.

The LWIP configuration may be used to add, modify or release DRBs that are using LWIP Tunnel.

The LWA configuration or the LWIP configuration may be received by including an RRC Connection Reconfiguration message from network.

The UE may be in an RRC_CONNECTED.

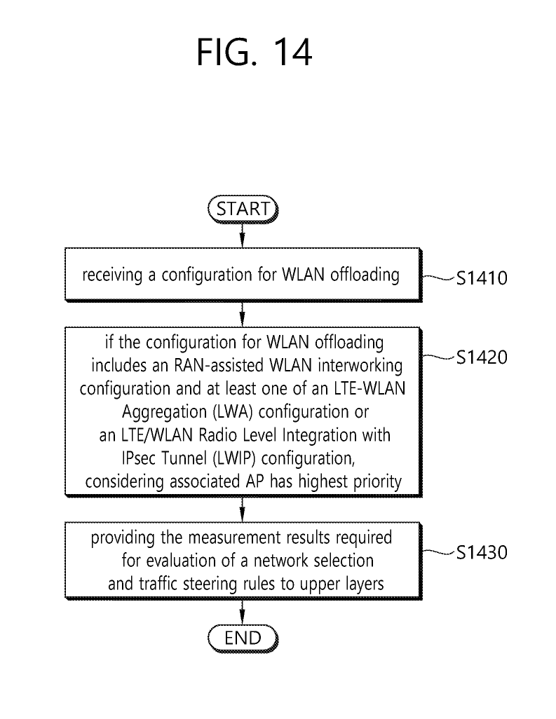

FIG. 14 is a block diagram illustrating a method for providing measurement results according to another embodiment of the present invention.

Referring to FIG. 14, in step S1410, the UE may receive a configuration for WLAN offloading.

In step S1420, if the configuration for WLAN offloading includes an RAN-assisted WLAN interworking configuration and at least one of an LTE-WLAN Aggregation (LWA) configuration or an LTE/WLAN Radio Level Integration with IPsec Tunnel (LWIP) configuration, the UE may consider associated AP has highest priority.

In step S1430, the UE may provide the measurement results required for evaluation of a network selection and traffic steering rules to upper layers.

The measurement results may be provided for the RAN-assisted WLAN interworking.

The LWA configuration may be used to setup, modify or release LTE-WLAN Aggregation.

The LWIP configuration may be used to add, modify or release DRBs that are using LWIP Tunnel.

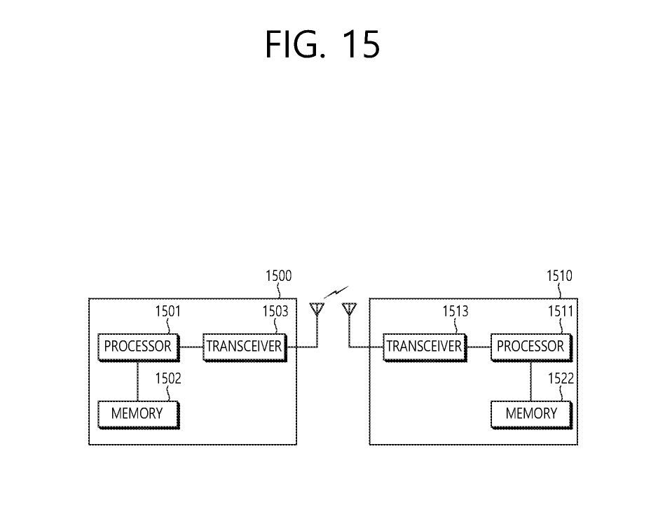

FIG. 15 is a block diagram illustrating a wireless communication system according to the embodiment of the present invention.

A BS 1500 includes a processor 1501, a memory 1502 and a transceiver 1503. The memory 1502 is connected to the processor 1501, and stores various information for driving the processor 1501. The transceiver 1503 is connected to the processor 1501, and transmits and/or receives radio signals. The processor 1501 implements proposed functions, processes and/or methods. In the above embodiment, an operation of the base station may be implemented by the processor 1501.

A UE 1510 includes a processor 1511, a memory 1512 and a transceiver 1513. The memory 1512 is connected to the processor 1511, and stores various information for driving the processor 1511. The transceiver 1513 is connected to the processor 1511, and transmits and/or receives radio signals. The processor 1511 implements proposed functions, processes and/or methods. In the above embodiment, an operation of the base station may be implemented by the processor 1511.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The transceiver may include a base-band circuit for processing a wireless signal. When the embodiment is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

Various methods based on the present specification have been described by referring to drawings and reference numerals given in the drawings on the basis of the aforementioned examples. Although each method describes multiple steps or blocks in a specific order for convenience of explanation, the invention disclosed in the claims is not limited to the order of the steps or blocks, and each step or block can be implemented in a different order, or can be performed simultaneously with other steps or blocks. In addition, those ordinarily skilled in the art can know that the invention is not limited to each of the steps or blocks, and at least one different step can be added or deleted without departing from the scope and spirit of the invention.

The aforementioned embodiment includes various examples. It should be noted that those ordinarily skilled in the art know that all possible combinations of examples cannot be explained, and also know that various combinations can be derived from the technique of the present specification. Therefore, the protection scope of the invention should be determined by combining various examples described in the detailed explanation, without departing from the scope of the following claims.

What is claimed is:

1. A method for providing, by a user equipment (UE), measurement results in a wireless communication system, the method comprising:
receiving a configuration for WLAN offloading; and
if the configuration for WLAN offloading includes an RAN-assisted WLAN interworking configuration, and does not include an LTE-WLAN Aggregation (LWA) configuration and an LTE/WLAN Radio Level Integration with IPsec Tunnel (LWIP) configuration, providing the measurement results required for evaluation of a network selection and traffic steering rules to upper layers.

2. The method of claim 1, wherein the measurement results is provided for the RAN-assisted WLAN interworking.

3. The method of claim 1, further comprising:
evaluating the network selection and the traffic steering rules.

4. The method of claim 1, further comprising:
if the configuration for WLAN offloading includes the RAN-assisted WLAN interworking configuration and at least one of the LWA configuration or the LWIP configuration, stopping providing the measurement results required for the evaluation of the network selection and the traffic steering rules to the upper layers.

5. The method of claim 1, wherein the RAN-assisted WLAN interworking configuration is either wlan-OffloadConfigCommon or wlan-OffloadConfigDedicated.

6. The method of claim 1, wherein the RAN-assisted WLAN interworking is performed based on the access network selection and the traffic steering rules.

7. The method of claim 1, wherein the RAN-assisted WLAN interworking is performed based on ANDSF policies.

8. The method of claim 1, wherein the LWA configuration is used to setup, modify or release LTE-WLAN Aggregation.

9. The method of claim 1, wherein the LWIP configuration is used to add, modify or release DRBs that are using LWIP Tunnel.

10. The method of claim 1, wherein the LWA configuration or the LWIP configuration is received by including an RRC Connection Reconfiguration message from network.

11. The method of claim 1, wherein the UE is in an RRC_CONNECTED.

12. A method for providing, by a user equipment (UE), measurement results in a wireless communication system, the method comprising:
receiving a configuration for WLAN offloading;
if the configuration for WLAN offloading includes an RAN-assisted WLAN interworking configuration and at least one of an LTE-WLAN Aggregation (LWA) configuration or an LTE/WLAN Radio Level Integration with IPsec Tunnel (LWIP) configuration, considering associated AP has highest priority; and
providing the measurement results required for evaluation of a network selection and traffic steering rules to upper layers.

13. The method of claim 12, wherein the measurement results is provided for the RAN-assisted WLAN interworking.

14. The method of claim 12, wherein the LWA configuration is used to setup, modify or release LTE-WLAN Aggregation.

15. The method of claim 12, wherein the LWIP configuration is used to add, modify or release DRBs that are using LWIP Tunnel.
